(19) United States
(12) Patent Application Publication
(10) Pub. No.: US 2019/0333150 A1
(43) Pub. Date: Oct. 31, 2019

(54) VOLATILITY INDEX AND DERIVATIVE CONTRACTS BASED THEREON

(71) Applicant: MIAMI INTERNATIONAL HOLDINGS, INC., Princeton, NJ (US)

(72) Inventors: VINAY RAO, Collegeville, PA (US); Anatoly Khusid, Moorestown, NJ (US); Bart Smith, Ridley Park, PA (US); David Lehmann, Lumberton, NJ (US); David Blackman, Elkins Park, PA (US); Siddharth Sahoo, Bridgewater, NJ (US); Matt Rotella, New Hope, PA (US); Shelly Brown, Skillman, NJ (US); Simon Ho, Sidney (AU)

(21) Appl. No.: 16/399,232

(22) Filed: Apr. 30, 2019

Related U.S. Application Data
(60) Provisional application No. 62/664,462, filed on Apr. 30, 2018.

(51) Int. Cl. G06Q 40/04

(52) U.S. Cl. CPC G06Q 40/04

(57) ABSTRACT

An improved volatility index and related derivatives contracts are provided. An index in accordance with the principals of the present invention estimates expected volatility from the prices of stock options in a wide range of strike prices. Also, an index in accordance with the principals of the present invention is calculated from a price dragging methodology to derive expected volatility. In accordance with another aspect of the present invention, derivative contracts such as futures and options based on the volatility index of the present invention are provided.

### CROSS-REFERENCE TO RELATED APPLICATIONS

The present application claims the benefit of U.S. Provisional App. No. 62/664,462, filed Apr. 30, 2018, the entirety of which is hereby incorporated herein by reference.

### BACKGROUND

In 1993, the Chicago Board Options Exchange (“CBOE®”) introduced the CBOE Volatility Index®, (“VIX®”). The VIX® index became a benchmark for stock market volatility, measuring market expectations of near term volatility conveyed by stock index option prices. Since volatility often signifies financial turbulence, the VIX® index was often referred to as the “investor fear gauge”.

The construction of VIX® was changed in 2003 to take advantage of theoretical replicating strategies for over-the-counter variance swaps. Since its re-design in 2003, VIX® has been the cost of a portfolio of out-of-the-money (OTM) options written on the S&P 500 (SPX). The weighting scheme combines the mid-point of bid and ask SPX option quotes at almost all of the OTM strikes and for two maturities which straddle 30 days. The across-strike weights are designed to equate the cash gamma contribution from each option, while the across-maturity weights are designed to target a 30 day forecasting horizon. The emphasis on bid and ask quotes rather than on trades and the volumes in out-of-the-money SPX options on VIX® settlement have led to questions of whether VIX® can be manipulated. See Griffin, J. and A. Shams, 2018 Manipulation in the VIX? Review of Financial Studies, 31, 4, 1, 1377-1417.

Although the VIX® index has been widely followed, it lacks multiply—listed derivatives contracts for its underlying inputs—which would reduce the potential for manipulation of the index. It would therefore be desirable to have an improved volatility index that is derived from underlying inputs that are listed on a plurality of financial exchanges.

### SUMMARY

A computer system for calculating an ongoing price for a derivative component of an index is disclosed. In an embodiment, program space is used to store at least one program, and at least one processor executes the at least one program, the at least one processor operating user space for local memory storage, which when executed, causes a market data receiver to initially set a reference price of a derivative to 0, the market data receiver autonomously determining a presence of a trade of the derivative, and if the trade is present, subsequently setting the reference price to the trade price, and if the trade is absent, subsequently setting the reference price to an opening bid price. The market data receiver identifies newly-placed trades and quotes for buying or selling the derivative. If the ongoing price for the derivative is different than the newly-placed trade, setting the reference price to the newly-placed trade price.

### BRIEF DESCRIPTION OF THE DRAWINGS

FIG. 1 is a diagram of computer system according to one embodiment of the present invention.

### DETAILED DESCRIPTION

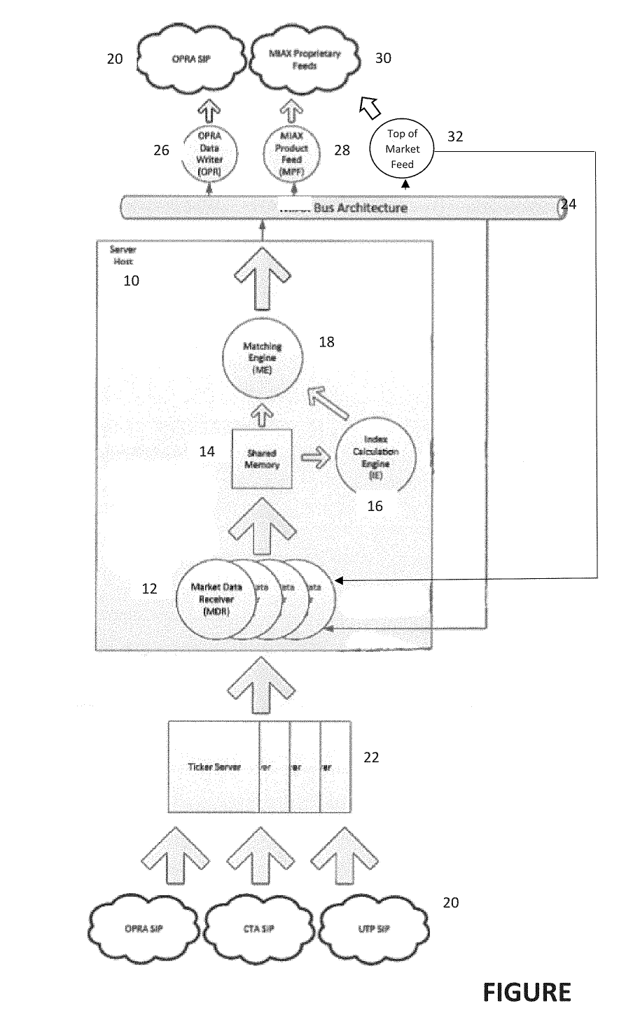

Referring to FIG. 1, a computer system is shown having a server host 10 that is dedicated to hosting one or more modules or programs for calculating an ongoing price for a derivative component of an index. Market data receiver 12 receives quotes for securities, such as options, trades for securities, and other index calculation components from one or more securities information processors 20. Securities information processors 20 may include data from one or more financial exchanges trading securities used in calculating the derivative component of an index. In an embodiment, securities information processors 20 use market data lines to deliver quotes and trades from options markets, quotes and trades for listed securities symbols from all listed markets, and quotes and trades for unlisted trading privileges from all listed markets to one or more ticker servers 22. Ticker servers 22 process data received from securities information processors 20 and transmit the processed data to market data receiver 12.

In an embodiment, market data receiver 12 pre-calculates components of an index algorithm, for example price dragging values, based on quotes and/or trades received from one or more ticker servers 22 (from one or more securities information processors 20) and stores those components in shared memory 14.

Shared memory 14 is shared by market data receiver 12, index calculation engine 16, and matching engine 18. Index engine 16 polls the shared memory every ‘n’ milliseconds, reads the pre-calculated index components from market data receiver 12, calculates the index and upon completion of the index calculation writes an index message to matching engine 18. Matching engine 18 writes the index message to bus architecture 24. OPRA data writer 26 and exchange product feed 28 receive the index message from bus architecture 24 and reformat it, respectively, as appropriate, for the intended destination and write it for dissemination via one or more securities information processors 20 and exchange proprietary feeds 30. Market data receiver 12 receives the index value and populates the index value in shared memory 14 for use by trading logic.

In the event of a failure by one or more securities information processors 20, Top-of-Market feed 32 may be used as an input into the index algorithm via market data receiver 12. As described herein above, market data receiver 12 pre-calculates components of an index algorithm, for example price dragging values; however, in the event of a failure by one or more securities information processors 20, the pre-calculation may be based on quotes and/or trades received from Top-of-Market feed 32 and stores those components in shared memory 14.

In an embodiment, calculating the volatility index of the present invention (“MVolIdx”) begins with selecting the Volatility Underlying Class (VUC) Options Expirations used for the calculation. For example, to calculate a monthly 30-day volatility index, use the front two monthly VUC expirations and ignore weekly and quarterly expirations. For a monthly expiration with less than two trading days until the expiration date, if it is a standard front month Friday expiration, the last day to use that front month Friday monthly expiration is Wednesday (even if either day is a half day). If Friday is an Exchange holiday (meaning expiration is Thursday), the last day to use that front month monthly expiration is Tuesday (even if either remaining day is a half day). If Thursday is an Exchange holiday, the last day to use that front month expiration is Tuesday (even if either remaining day is a half day). In an embodiment, a weekly 30-day volatility index uses the two VUC expirations closest to 30 days from the settlement of the weekly MVolIdx settlement, inclusive of weekly and monthly expirations, where a monthly could be a fourth week or fifth week. Ignore quarterly expirations, unless it is also a Friday.

For each volatility index calculation, define the Risk Free Interest Rate for each expiration used. The yield (mid-point of bid-ask) for the United States Treasury Bill which matures on the date closest to each VUC Options expiration is used in the calculation—generally the day prior to the Friday expiration date. If there are multiple Treasury securities, the shortest dated maturity is used. Any new value is compared to the prior value, for example: absolute value of the new rate minus the rate currently used in the model. If the absolute value of the difference is greater than “X”, ignore the new value and issue an alert:

Where “X” is configurable; expressed as an interest rate (for example, 1.00%); an acceptable range of 0.01% to 10.00%, in 0.01% precision. Initial value will be, for example, 1.00%. In this example, 1.00% change (or less) is acceptable (i.e. from 1.35% to 2.35% or 0.35%), but a 1.01% change (or more) is not (i.e. from 1.35% to 2.36% or 0.34%).

Example 1: “X”=0.75%

Current rate is 1.37% (0.0137); New rate is 1.35% (0.0135)

Absolute value of the difference is 0.02% (0.0002)

0.02% is less than 0.75%, so use the new value

Example 2: “X”=0.75%

Current rate is 1.37% (0.0137); New rate is 2.35% (0.0235)

0.98% is greater than 0.75%, so ignore new value and issue an alert

The system will need the ability to enter a value autonomously or manually, in order to override the automated Risk Free Interest Rate input, in the event of a system problem or an errant value.

For each volatility index calculation, determine the Reference Price for each derivative—in this embodiment, options—in each VUC expiration used. In an embodiment, determination of the Reference Price begins at the opening of the financial markets, or if the opening is delayed, beginning at the delayed time. All options listed on the exchange performing the volatility index calculation are used in the process, and if an option is added intra-day, include that option in future calculations. If an option is made non-tradeable intraday, exclude that option in future calculations, until such time that it is re-added. Options not listed on the calculating exchange are excluded. Each option begins with a Reference Price of zero (0). Price dragging is utilized as described herein below:

Price Dragging

Once an option has opened for trading, the system updates the Reference Price upon each of the following, in real-time:

A new eligible trade from any exchange: Always use the new trade price

Only include trades with an OPRA (Options Price Reporting Authority) Trade condition of:
Regular: code is “ ” (space);
AUTO: code is “I”; or
REOP: code is “J”; and
Ignore trades that are not in an even penny increment

Using only National Best Bid or Offer (“NBBO”) eligible bids and offers from all eligible exchanges (both the bid and offer side with quote conditions A, B, C, O or “space” plus the bid side of X and the offer side of Y):
Ignore quotes that are not in an even penny increment;
A new eligible bid from any exchange greater than the existing Reference Price (use the new bid price); and
A new non-zero eligible ask from any exchange less than the existing Reference Price (use the new ask price)

Exclusions from the Price Dragging process (not eligible):
Trades, Bids and asks from any exchange which has been declared to be Self-Helped by the exchange calculating the volatility index;
Bids and asks from any exchange which is crossing its own market; and
Pre-opening bids and asks

If the Underlying for the VUC Halts Trading in the primary market:
MVolIdx Index Calculation is suspended; and
Continue the price dragging process for the Reference Price for all VUC options

Index Price Calculation

Trigger to begin the process of calculating the index value:

At the start of the trading day, begin the process of calculating the Index Value X seconds after the opening time for the VUC. If the VUC opening is delayed, wait “X” seconds after the VUC opens for trading in the primary market. In an embodiment, a MVolIdx Calculation Wait Timer (VCWT) is used. X is configurable, in seconds. VCWT is used at the market opening and re-opening, and for any re-start of the Index Value calculation.

After a VUC trading Halt, begin the process of calculating the Index Value X seconds after the re-opening of the VUC on the Primary Market and use the same VCWT.

After the forced re-start of the calculation of the Index Value, begin the process of calculating the Index Value after X seconds. An automated stop may be used if there is a halt in the VUC, or an override may be used to ignore a subsequent halt in the VUC. In the event of a recalculation, the same VCWT may be used.

Trigger to Stop the Process of Calculating the Index Value

Upon a trading halt in the VUC in the primary market, the calculation of the index value stops. The calculation of the index value also stops at the close of VUC trading (for example, 4:00 ET or 4:15 ET), based on the VUC Options closing time. The calculation of the index value may also stop at the close of VUC trading (for example, 1:00 ET or 1:15 ET), based on an early VUC Options closing time.

Additionally, the calculation of the index value, once stopped, may include an automated restart if there is a re-opening in the VUC. An override may be used to ignore an automated restart if there is a re-opening in the VUC. When stopping the calculation of the index value due to a halt or manual intervention, the price dragging process is not stopped.

In order to calculate the volatility index of the present invention, the At-the-Money (ATM) Strike Price must be determined. To do so, the Call-Put crossover may be identified, ignoring strikes with a Call and/or a Put with a Reference Price of zero. If there is a single crossover, use the closest strike to the crossover—which may be the strike with the lowest absolute value of the Call Reference Price minus the Put Reference Price. If there is a tie between two or more strikes, use the lower strike. Ignore strikes where either (or both) the Call and the Put have a Reference Price of zero.

If there are: (i) multiple crossovers, (ii) no crossovers or (iii) the crossover is more than X % from the VUC cash, where the VUC cash is defined as the last VUC Trade Price from all exchanges, then the eligible strike price closest to the last VUC Trade Price may be used. If there is a tie, the lower of the two strike prices may be used.

Selection of Strikes to be used may be done by organizing all strikes in the expiration month from lowest to highest. For Calls, use the ATM Call plus all higher strike Calls limited to the first of: two consecutive Calls with a Reference Price equal to or less than $0.05 (ignoring Calls with a Reference Price of zero), or the highest strike price available. For Puts, use the ATM Put plus all lower strike Puts limited to the first of: two consecutive Puts with a Reference Price equal to or less than $0.05 (ignoring Puts with a Reference Price of zero), or the lowest strike price available.

MVolIdx Index Settlement Price Calculation

Select the VUC Options Expirations used for the calculation, for a monthly 30 Day Volatility Index, use the monthly VUC Options expiration exactly 30 calendar days away from the VUC monthly expiration day. This may be the front VUC expiration, if the expiration is a five week (35 day) cycle, or the back expiration if the expiration is a four week (28 day) cycle. If the MVolIdx settlement day is an Exchange holiday, move the settlement to the prior trading day. This does not impact use of the VUC expiration day and yields a 31-day vol settlement. If the VUC expiration is Thursday (due to a Friday Exchange holiday), the MVolIdx settlement is on the Tuesday 30 days prior. In the case of an unexpected close of the markets on the scheduled Wednesday settlement day expiration, the MVolIdx Settlement is on the Thursday 29 days prior. Ignore weekly VUC expirations, quarterly VUC expirations, and a monthly VUC expiration with less than 2 full days to expiration date.

For a weekly 30-Day Volatility Index, use the VUC Options expiration exactly 30 calendar days away from the VUC weekly expiration day. If the MVolIdx Settlement day is an Exchange holiday, move the Settlement to the prior trading day. This does not impact using the VUC expiration day and yields a 31 day vol settlement. If the VUC expiration is Thursday (due to a Friday Exchange holiday), the MVolIdx settlement is on the Thursday 29 days prior. In the case of an unexpected close of the markets on the scheduled Friday settlement day expiration, the MVolIdx settlement is on the Monday 4 days prior.

For the volatility index of the present invention, define the Risk Free Interest Rate for the Expiration used for the calculation by using the yield (mid-point of bid-ask) for the United States Treasury Bill which matures on the date closest to the monthly (or weekly) VUC expiration. This is generally the day prior to the monthly (or weekly) expiration date. If there are multiple Treasury securities, use the shortest dated maturity. Compare any new value to the prior value:
Absolute value of the new rate minus the rate currently used in the model
If the absolute value of the difference is greater than “X”, ignore the new value and issue an alert
Where “X” is:
   Configurable
   Expressed as an interest rate (for example, 1.00%)
   Acceptable range of 0.01% to 10.00%, in 0.01% precision

Example 1: “X”=0.75%
Current rate is 1.37% (0.0137)
New rate is 1.35% (0.0135)
Absolute value of the difference is 0.02% (0.0002)
0.02% is less than 0.75%, so use the new value

Example 2: “X”=0.75%
Current rate is 1.37% (0.0137)
New rate is 2.35% (0.0235)
Absolute value of the difference is 0.98% (0.0098)
0.98% is greater than 0.75%, so ignore new value and issue an alert

The system has the ability to enter a value to override the automated Risk Free Interest Rate input, in the event of a system problem or an errant value.

Determination of the Settlement Reference Price (SRP) for each option in the VUC Expiration used for the calculation:

For options used in the SRP calculation, use the exchange opening trade price or exchange opening bid ask quote for all VUC options in the expiration used for the settlement calculation. The exchange will open the VUC settlement expiration with a revised Opening Process, which utilizes a Special Settlement Imbalance Process.

SRP at the Open:

Using the exchange Opening bid, ask and trades, once each option is open, if the exchange opens with a trade, the SRP is the trade price. Routing away, without a trade on the exchange does not constitute a trade, although the “flip” trade upon return of a routed order “fill” would be considered a trade.

If the exchange opens without a trade, include all liquidity in determining the initial Settlement Opening bid and ask. This includes OPG, AOC and SAO orders and eQuotes. Each near In-The-Money (ITM), At-The-Money (ATM) and Out-of-The-Money (OTM) option with a Settlement Opening bid ask spread equal to or less than the Settlement Reference Price Opening Width table value using the VUC specific Settlement Reference Price Opening Width table, which is the width of the exchange bid ask spread, not each individual Market Maker quote. The VUC width is not used for ITM options. The midpoint of the Settlement Opening bid and ask for the SRP may also be used—the exact midpoint, which could be a half penny increment (no rounding).

Deep ITM Calls and Puts are not subject to the Settlement Reference Price Opening Width Table parameters. Deep ITM Calls are ITM by more than the IPATMC (defined above as having a strike less than the VUC Cash by more than the IPATMC) and deep ITM Puts are ITM by more than the IPATMC (strike is greater than the VUC Cash by more than the IPATMC) are exempt from the Opening Width requirement. Use the midpoint of the Settlement Opening bid and ask for the SRP—the exact midpoint, which could be a half penny increment (no rounding).

Example of deep ITM for SPY:
Assumptions
   SPY Cash is 270.25
   IPATMC is 5.0%
Calls with Strike Prices of less than $256.7375 are deep ITM and therefore exempt from the Opening Width requirement
   $270.25×95%=256.7375
Puts with Strike Prices of greater than $283.7625 are deep ITM and therefore exempt from the Opening Width requirement
   $270.25×105%=283.7625

If an option's Settlement Opening bid ask spread is greater than the Settlement Reference Price Opening Width table value, the option will open disseminating the wide market and AOC, OPG and SAO Orders and eQuotes will be cancelled upon the opening and not included in the initial disseminated wide market. Additionally, a Settlement Reference Price Timer (SRPT) will begin. The timer is configurable in whole seconds, with a range of 1 second to 60 seconds. An initial setting may be, for example, 15 seconds. A single timer is used per option and is counted from the option opening time. During the SRPT, the SRP remains zero until the first of the following:
If there is a trade on the exchange, the SRP is the trade price
If the option's bid ask spread becomes equal to or less than the Settlement Reference Price Opening Width table value, the SRP is the midpoint of the bid and ask (the exact midpoint, which could be a half penny increment (no rounding))
The end of the timer

If the SRPT expires before establishing a Settlement Reference Price, for each option:
i. If at any time after the SRPT expires, and before establishing a Settlement Reference Price using (ii) or (iii) below
   a. If there is a trade on the exchange, the SRP is the trade price
   b. If the option's bid ask spread becomes equal to or less than the Settlement Reference Price Opening Width table value, the SRP is the midpoint of the bid and ask—the exact midpoint, which could be a half penny increment (no rounding)
ii. Compare the exchange bid and ask to the current Reference Price used for the cash index calculation
   a. If the current Reference Price used for the cash index calculation is non-zero or becomes non-zero and equal to or inside the exchange bid and ask, use the current Reference Price used for the cash index calculation
   b. If the current Reference Price used for the cash index calculation is non-zero or becomes non-zero and greater than the exchange ask, use the exchange ask
   c. If the current Reference Price used for the cash index calculation is non-zero or becomes non-zero and less than the exchange bid, use the exchange bid
iii. If the current Reference Price used for the cash index calculation is zero
   a. If the one or both adjacent options of the same type (Calls and Calls or Puts and Puts) have or become a non-zero SRP, the option can be skipped (retains a zero SRP and not used in the Settlement Price Calculation
   b. If there are multiple options of the same type adjacent with a current Reference Price used for the cash index calculation of zero
      i. If the NBBO bid-ask spread is less than or equal to “Z”, use the midpoint of the current NBBO for the option, where “Z” will use a configurable multiplier of the Settlement Reference Price Opening Width table
      ii. If the NBBO bid-ask spread is greater than “Z”, wait until the first of i) a trade on any exchange, and use that trade price or ii) the NBBO bid-ask spread becomes less than or equal to “Z”, and use the midpoint of that NBBO, where “Z” will use a configurable multiplier of the Settlement Reference Price Opening Width table value
      iii. Where “Z” is configured globally
      iv. Range, in whole numbers from 2 to 10
      v. Likely starting value is 2
iv. Need a process to inject an SRP for each option, in the case of a catastrophic event

If the VUC halts during the MVolIdx Settlement process, keep the SRP for all options which have already opened. For those options in the expiration used for the calculation which have not yet opened or have yet to establish a SRP, upon the reopening of the VUC options use the Settlement Reference Price at the Open process described above once the VUC has re-opened on the exchange. Each option's Settlement Reference Price for the MVolIdx Settlement Value calculation may also be used.

Index Settlement Price Calculation

The Index Settlement Price calculation occurs on the morning of MVolIdx Expiration, and the pricing inputs are the SRPs for every option in the applicable VUC expiration. Once all of the VUC options in the expiration used for the settlement calculation have an SRP, the At-the-Money (ATM) Strike Price is determined. The Call-Put crossover is identified, as are the select strikes to be used (using the SRP rather than the Reference Price). A variance calculation is determined for each term used in the calculation by using the actual time the final SRP has been determined as the start time for the calculation, and the actual VUC close time at expiration as the end time.

Example:
MVolIdx Settlement Wednesday Jun 20, 2018 at 9:30 am ET
VUC Expiration Friday Jul. 20, 2018 at 4:15 pm ET
Final SRP established at 9:31:19 on Jun. 20, 2018
Time used is 30 days, less 00:01:19, plus 06:15:00

What is claimed is:

1. A computer system for calculating an ongoing price for a derivative component of an index, comprising:
program space to store at least one program; and
at least one processor executing the at least one program, the at least one processor operating user space for local memory storage, which when executed, causes:
a market data receiver to initially set a reference price of a derivative to 0, the market data receiver autonomously determining a presence of a trade of the derivative, and if the trade is present, subsequently autonomously setting the reference price to a trade price, and if the trade is absent, subsequently autonomously setting the reference price to an opening bid price; and
wherein the market data receiver autonomously identifies newly-placed trades and quotes for buying or selling the derivative, and if an ongoing price for the derivative is different than a newly-placed trade price, autonomously setting the reference price to the newly-placed trade price.

2. The computer system of claim 1, wherein if there is no newly-placed trade, then the market data receiver autonomously setting the reference price to a newly-placed quote for buying or selling the derivative.

3. The computer system of claim 2, wherein the reference price is set to a newly-placed ask quote, if an ask quote is lower than the reference price.

4. The computer system of claim 2, wherein the reference price is set to a newly-placed bid quote, if a bid quote is higher than the reference price.

5. The computer system of claim 1, wherein the reference price is stored in a shared memory.

6. The computer system of claim 2, further comprising an index calculation engine for calculating an index based at least in part on the reference price.

7. The computer system of claim 3, wherein the index calculation engine accesses the shared memory.
